(19) United States
(12) Patent Application Publication
(10) Pub. No.: US 2020/0109010 A1
(43) Pub. Date: Apr. 9, 2020

(54) RECIPROCATING ACCELERATION SIGNATURE MONITORING AND TREND ANALYSIS SYSTEM

(71) Applicant: Siemens Logistics LLC, DFW Airport, TX (US)

(72) Inventor: Michael D. Carpenter, Arlington, TX (US)

(21) Appl. No.: 16/592,429

(22) Filed: Oct. 3, 2019

Related U.S. Application Data
(60) Provisional application No. 62/742,693, filed on Oct. 8, 2018.

(51) Int. Cl. B65G 43/08; B65G 47/76; B65G 47/68; B64F 1/36

(52) U.S. Cl. CPC B65G 43/08; B65G 47/766; B65G 2201/0264; B64F 1/368; B65G 47/682

(57) ABSTRACT

A diverter system includes a diverter arm, an actuator assembly for operating the diverter arm, a position sensor for monitoring a motion signature of the diverter arm, and a control unit operably coupled to the position sensor and configured to evaluate the motion signature of the diverter arm.

### CROSS REFERENCE TO RELATED APPLICATIONS

This application claims benefit of U.S. provisional application No. 62/742,693 filed 8 Oct. 2018 in the United States Patent and Trademark Office, the content of which is herein incorporated by reference in its entirety.

### BACKGROUND

### 1. Field

Aspects of the present disclosure generally relate to a diverter system and a method for operating a diverter system. Such a diverter system is particularly suitable for use in baggage handling and parcel sortation systems.

### 2. Description of the Related Art

A diverter system, such as a high speed diverter, herein also referred to as HSD, is used for example for sorting baggage horizontally from a conveyor onto another conveyor. The HSD may also be used to reroute baggage in case of failure. HSDs utilize for example dual, belted arms that may be extended or retracted to cross a horizontal transport conveyor at an angle. When extended, the belted arms cause items, typically luggage within a baggage handling system, to be diverted to an adjacent conveyor. The belted arms may be said to reciprocate, or move back and forth, as they either cause items to be diverted from the horizontal belt or pass through.

The mechanism that establishes extension or retraction of the dual belted arms is driven by a motor and transmission that applies torque and power to a shaft. In an example, there is a crank on a gearmotor output shaft and cranks on each paddle (arm) mounting shaft. A difference in crank radii determines any difference in a range between dwell points at the gearmotor and at the paddles. In an exemplary configuration, when the gearmotor output shaft is rotated approximately 70 degrees back and forth, a motion is translated by the linkage to toggle the paddles in either the extended or retracted dwell positions of about 45 degrees of rotation. Of course, different crank radii and different degrees of rotation of the output shaft will provide different degrees of rotation of the paddles. Although a duty cycle on the motor is relatively low in typical applications, over time wear and damage can accumulate in the motor transmission and linkage.

Preventive maintenance for the HSD typically includes manually toggling the arms to watch and listen as they operate. Backlash in the transmission or loose couplings in the linkage cause noise and may even be visible in the motion of the arms. If this condition is not identified in preventive maintenance and repaired, a failure can occur during critical operations, causing delays and loss of productivity. Further, during operation, exceptions can occur due to the broad physical nature of baggage that may be pinched between the arms, which can damage the unit. Defective units may also exhibit motion abnormalities that affect proper operation.

### SUMMARY

A first aspect of the present disclosure provides a diverter system comprising a diverter arm, an actuator assembly for operating the diverter arm, a position sensor for monitoring a motion signature of the diverter arm, and a control unit operably coupled to the position sensor and configured to evaluate the motion signature of the diverter arm.

A second aspect of the present disclosure provides a method for operating a diverter system comprising monitoring a motion signature of a diverter arm between multiple dwell positions by a position sensor and analyzing the motion signature of the diverter arm by a local control unit.

A third aspect of the present disclosure provides a non-transitory computer readable medium storing computer executable instruction that, when executed by at least one processor, perform a method comprising receiving position sensor data of a motion signature of a diverter arm of a diverter system moving between multiple dwell positions, analyzing the position sensor data of the motion signature, and communicating received and analyzed position sensor data to a main control system.

### BRIEF DESCRIPTION OF THE DRAWINGS

FIG. 1 illustrates a plan view of a diverter system in accordance with an exemplary embodiment of the present disclosure.

FIG. 2 illustrates a flow chart of a method for operating a diverter system in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a diverter system and a method for operating a diverter system. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

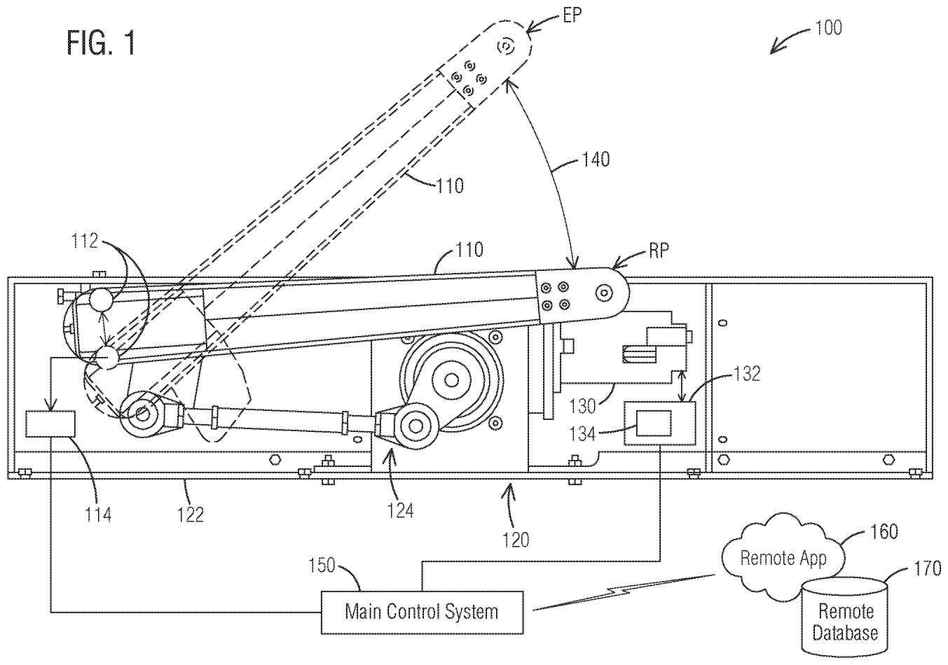

FIG. 1 illustrates a plan view of a diverter system 100 in accordance with an exemplary embodiment of the present disclosure. The diverter system 100 comprises a diverter arm 110 (also known as a paddle) and an actuator assembly 120 for operating and moving the diverter arm 110. The diverter arm 110 and the actuator assembly 120 are configured such that the diverter arm 110 is moveable between a retracted dwell position RP (also known as home position) and at least one extended dwell position EP (also known as diverting position). Movement of the diverting arm 110 is illustrated by path 140.

The diverter system 100 can be used within baggage handling systems, for example at airports, parcel handling systems within mail processing facilities, or many other handling systems including for example automated sortation systems etc. In an embodiment, the diverter system 100 is configured as high-speed diverter system.

The diverter system 100 of FIG. 1 illustrates one diverter arm 110, but it should be noted that the diverter system 100 can comprise multiple diverter arms 110, located at different positions within the diverter system 100. For example, the diverter system 100 can comprise dual belted arms 110, the arms 110 being essentially arranged opposite each other.

In an embodiment, the actuator assembly 120, which operates the diverting arm 110, is housed in enclosure 122 and comprises a gearmotor 130 and a drive 132. The drive 132 is only illustrated schematically and may be integrated in the gearmotor 130 or may be a separate component. The gearmotor 130 is operably coupled to the diverter arm 110, and the drive 132 is configured to power and control the gearmotor 130. The gearmotor 130 comprises a plurality of stages, wherein an output stage functions as a shaft for turning or moving the diverting arm 110 from position RP to extended dwell position EP.

The diverter arm 110 is pivotally mounted for example adjacent a conveyor or other transporting means, such as a transporting belt. For diverting articles or objects, the diverter arm 110 is moved from the retracted dwell position RP to an extended dwell position EP, wherein the arm 110 moves across a surface of the conveyor or transporting means to divert objects or articles travelling on the surface in a diverting direction. For example, the diverting arm 110 is moved along path 140 up to a specific angle between RP and EP, for example an angle of about between 40° and 50°.

In an embodiment, the gearmotor 130 comprises a servo motor, and the drive 132 comprises a variable frequency drive (VFD), for example a servo drive, operably coupled to the servo motor and powering and controlling the servo motor. The drive 132 can be integrated in the gearmotor 130 and generally provides speed adjustments, for example for belts or other means that operate or move the diverting arm(s) 110.

In an example, the actuator assembly 120, specifically the drive 132, comprises a control unit 134 storing computer executable instructions, executable by at least one processor, for example to adjust speeds of the gearmotor 130 and thereby moving the stages (gears) of the gearmotor 130 and moving the diverting arm 110.

Although a duty cycle on the gearmotor 130 is relatively low in typical applications, over time wear and damage can accumulate in the motor transmission and linkage. Preventive maintenance typically includes manually toggling the arms 110 to watch and listen as they operate. Backlash in the transmission or loose couplings in the linkage cause noise and may even be visible in the motion of the arms 110. If this condition is not identified in preventive maintenance and repaired, a failure can occur during critical operations, causing delays and loss of productivity.

Thus, in accordance with an exemplary embodiment of the present disclosure, the diverter system 100 comprises a position sensor 112 for monitoring a motion signature of the diverter arm 110. Subsequent use of the equipment, e.g. the diverter arm 110 or the linkage, e.g. components of the actuator assembly 120, in operation allows a motion signature to be observed, in reference to control signals that identify start and completion of a signature, wherein resulting motion signatures can be evaluated in different ways. A motion signature of the diverter arm 110 is or describes a motion sequence or course of movement from the retracted position RP to the extended position EP along path 140.

Further, a control unit 114 is operably coupled to the position sensor 112 and configured to evaluate or analyze the motion signature of the diverter arm 110. The control unit 114 can be configured as local controller, for example an embedded microcontroller. The control unit 114 can be integrated or incorporated in existing control equipment, for example control unit 134 of drive 132. In another example, the control unit 114 may be separate component. The control unit 114 can be software or a combination of software and hardware. For example, the control unit 114 can be programmed into existing equipment, for example as software module into drive control unit 134 or other control and monitoring equipment of the diverter system 100.

The diverter system 100 or local control unit 114 can further comprise an analog-digital converter for converting a monitored/recorded motion signature (analog signal) into a digital signal of the motion signature, so that the digital motion signature can then be evaluated and compared to the previously stored digital reference signature.

The control unit 114 is configured to compare the actual motion signature of the diverter arm 110, when in operation, to a previously stored reference signature of a reference diverter arm. A reference (motion) signature is or describes a motion sequence of a correctly operating diverter arm without any malfunctions or wear.

Motion signatures or spectra can be created using various algorithmic means, including for example Fast Fourier Transformation (FFT) and various wave-based approaches.

In an example, a comparison of the motion signature of the diverter arm 110 with the reference signature comprises determining a degree of difference between the signatures. For example, a degree of difference can be determined between the dwell positions RP and EP and reference dwell positions of the reference signature. The motion signature of the diverter arm 110 may describe a range or angle between dwell positions RP and EP of 43°, wherein the optimal reference signature comprises a range or angle between optimal dwell positions of 45°. Thus, the difference would be 2°. The diverter system 100 is still functioning, but a maintenance condition may be identified prior to malfunction or failure of the diverter system 100.

The evaluation method of comparing the motion signature with the reference signatures is a means of recording and measuring wear in the system 100, or of determining that linkage is otherwise becoming loose. When the difference between the two spectra exceeds established parameters, a technician or maintenance personnel is notified. Early detection and resolution of these conditions allows them to be dealt with outside of operational schedules.

In another embodiment, the control unit 114 is configured to compare the motion signature of the diverter arm 110 to one or more fixed thresholds. The evaluation method of comparing the motion signature to fixed threshold(s) involves monitoring to identify instances in which a rate of change, or “jerk” exceeds established parameters, which is thought to be indicative of a malfunction or of an item exceeding specification(s) being processed. Such fixed thresholds include for example motion parameters such as speed of the diverting arm 110, or angle of the moving arm 110 when in dwell positions RP, EP. Further, parameters may include timing of the divert operation according to contact of items on the arm(s) 110 after the arm(s) 110 have activated. Incorrect parameters can be slow speed, incorrect angle/range or incorrect timing with respect to the diverting arm 110.

The position sensor 112 comprises at least one accelerometer or accelerometer sensors, for example a 3-dimensional accelerometer. An accelerometer measures acceleration due to movement and gravity. An accelerometer can be used to measure or track positions of a component, such as the diverting arm 110. The accelerometer will not be described in detail herein as those skilled in the art are familiar with position sensors and accelerometers.

The position sensor 112 comprising the at least one accelerometer is affixed in at least one axis of the diverter arm 110. It should be noted that the diverter arm 110 may comprise more than one position sensor 112, such as accelerometers, for example two or three positions sensors mounted at different locations of the diverter arm 110.

As noted, the diverter system 100 can comprise multiple diverter arms 110 and thus multiple position sensors 112, embodied as accelerometers, wherein each diverter arm 110 can comprise one or more position sensors 112. In this case, the local control unit 114 is operably and communicatively coupled to the multiple position sensors 112.

The local control unit 114 is communicatively coupled to a main control system 150, wherein the control unit 114 is further configured to communicate evaluated motion signatures of the diverter arm 110 to the main control system 150. The main control system 150 can be configured to provide or output a signal or message with respect to a condition of the diverter arm 110, such as for example that maintenance or repair is required based on evaluated motion signature(s) of the diverter arm 110. Such a signal or message can be for example displayed on a screen or a display to an operator, technician or maintenance personnel.

In another configuration, the main control system 150 is configured to communicate, wirelessly, the evaluated motion signatures to a remote cloud-based application 160 and/or a remote database 170 for further processing, such as remote technical support, for example recommendations as to maintenance service or automatic ordering of parts that need replacement. Storing and analyzing the motion signatures or spectra (remotely or otherwise), particularly comparing the spectra from many different diverter systems 100, and correlating conditions and events that have correlated to particular patterns in the spectra offers potential to associate trends with very specific likely outcomes.

Those of skill in the art will recognize that not all details are shown or described in the system 100 of FIG. 1. For example, the housing or enclosure 122 may house other components of the diverter system 100, such as arm belts and/or other mechanical or electromechanical components 124.

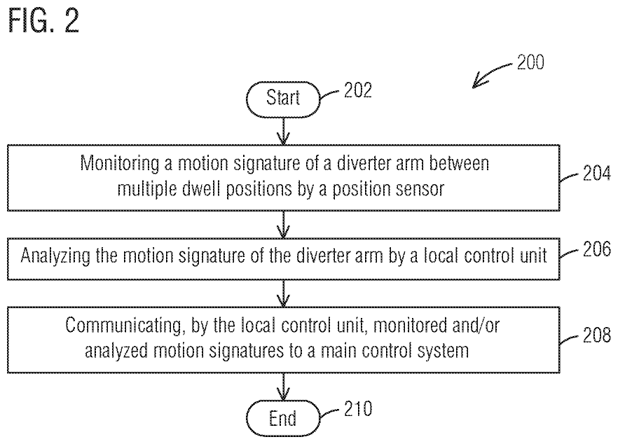

FIG. 2 illustrates a flow chart of a method 200 for operating a diverter system 100 in accordance with an exemplary embodiment of the present disclosure. While the method 200 is described as a series of acts that are performed in a sequence, it is to be understood that the method 200 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

In an exemplary embodiment, the method may start at 202 and may comprise an act or process 204 of monitoring a motion signature of a diverter arm 110 between multiple dwell positions RP, EP by a position sensor 112. The method 200 may further include an act 206 of analyzing the motion signature of the diverter arm 110 by a local control unit 114, and an act 208 of communicating, by the local control unit 114, recorded and/or analyzed motion signatures to a main control system 150, wherein the main control system 150 is configured to provide a signal or message with respect to a condition of the diverter arm 110 and/or the diverter system 100.

As described with reference to FIG. 1, analyzing comprises comparing the motion signature of the diverter arm 110 to a previously stored reference signature of a reference diverter arm 110, wherein comparing comprises determining a degree of difference between the multiple dwell positions EP, RP of the diverter arm 110 to reference dwell positions of the reference signature. Analysis of the motion signature of the diverter arm 110 may further comprise comparing the motion signatures of the diverter arm 110 to one or more fixed thresholds.

The method 200 may further comprise communicating, by the main control unit 150, the recorded and/or analyzed motion signatures of the diverter arm(s) 110 to a remote cloud-based application 160 and/or remote database 170 for further processing, such as for example remote technical support.

In another exemplary embodiment of the present disclosure, a non-transitory computer readable medium, storing computer executable instructions, is provided. The non-transitory computer readable medium comprises software instructions for the control unit 114, embodied for example as embedded microcontroller, and operably coupled to the position sensor 112. When executed, a method is performed comprising receiving position sensor data of a motion signature of a diverter arm of a diverter system moving between multiple dwell positions, analyzing the position sensor data of the motion signature, and communicating received and analyzed position sensor data to a main control system. Further acts and details of the method relating to the non-transitory computer readable medium are described with reference to FIG. 1 and FIG. 2.

The described system 100 and method 200 allows significantly more insight into the condition of the equipment and provides increased likelihood that maintenance conditions can be identified and dealt-with without allowing the system to fail during operation.

Monitoring the diverting arm(s) 110 of a diverter system 100, or the linkage that controls position of the diverter arm(s) in a 3-dimensional space provides and enables:
Identifying excessive backlash in the movement of the diverting arm(s).
Identifying incorrect motion parameters, slow speed, etc.
Identifying incorrect timing of the divert operation, according to the contact of items on the arms 110 after they have activated.
Identifying harmful exceptions in the course of normal operation, such as a “pinched bag,” a strap or other part of a bag caught in the arms, etc.
Identifying failure to operate at all when triggered.

While embodiments have been disclosed in exemplary forms, it will be apparent to those skilled in the art that many modifications, additions, and deletions can be made therein without departing from the spirit and scope of the disclosure and its equivalents, as set forth in the following claims.

1. A diverter system comprising:
a diverter arm,
an actuator assembly for operating the diverter arm,
a position sensor for monitoring a motion signature of the diverter arm, and
a control unit operably coupled to the position sensor and configured to evaluate the motion signature of the diverter arm.

2. The diverter system of claim 1, wherein the control unit is configured to compare the motion signature of the diverter arm to a previously stored reference signature of a reference diverter arm.

3. The diverter system of claim 2, wherein the motion signature of the diverter arm comprises a motion from a retracted dwell position to an extended dwell position over a dwell range, and wherein a comparison of the motion signature to the reference signature comprises determining a degree of difference between the dwell positions of the diverter arm and reference dwell position of the reference signature.

4. The diverter system of claim 1, wherein the control unit is configured to compare the motion signature of the diverter arm to one or more fixed thresholds.

5. The diverter system of claim 5, wherein the one or more fixed thresholds comprise a speed threshold and/or a range threshold of the diverter arm.

6. The diverter system of claim 1, wherein the position sensor comprises at least one accelerometer.

7. The diverter system of claim 6, wherein the at least one accelerometer is affixed in at least one axis of the diverter arm.

8. The diverter system of claim 1, comprising multiple diverter arms and multiple position sensors, wherein each diverter arm comprises one or more position sensors, and wherein the control unit is operably coupled to the multiple position sensors.

9. The diverter system of claim 1, wherein the control unit is communicatively coupled to a main control system, and wherein the control unit is further configured to communicate evaluated motion signatures of the diverter arm to the main control system.

10. The diverter system of claim 1, wherein the main control system is configured to communicate evaluated motion signatures to a remote cloud-based application or a remote database via a wireless communication link.

11. A method for operating a diverter system comprising:
monitoring a motion signature of a diverter arm between multiple dwell positions by a position sensor, and
analyzing the motion signature of the diverter arm by a local control unit.

12. The method of claim 11, wherein evaluating comprises comparing the motion signature of the diverter arm to a previously stored reference signature of a reference diverter arm.

13. The method of claim 12, wherein comparing comprises determining a degree of difference between the multiple dwell positions of the diverter arm to reference dwell positions of the reference signature.

14. The method of claim 11, wherein evaluating comprises comparing the motion signatures the diverter arm to one or more fixed thresholds.

15. The method of claim 11, wherein the position sensor comprises at least one accelerometer affixed to the diverter arm.

16. The method of claim 11, further comprising:
communicating, by the local control unit, recorded and/or analyzed motion signatures to a main control system, wherein the main control system is configured to provide a signal or message with respect to a condition of the diverter arm.

17. The method of claim 16, further comprising:
communicating, by the main control system, the recorded and/or analyzed motion signatures of the diverter arm to a remote cloud-based application for further processing and/or remote technical support.

18. A non-transitory computer readable medium storing computer executable instruction that, when executed by at least one processor, perform a method comprising:
receiving position sensor data of a motion signature of a diverter arm of a diverter system moving between multiple dwell positions,
analyzing the position sensor data of the motion signature, and
communicating received and analyzed position sensor data to a main control system.

19. The non-transitory computer readable medium of claim 18, wherein analyzing comprises comparing the position sensor data of the motion signature to a previously stored reference signature of a reference diverter arm and/or comparing the position sensor data of the motion signature to one or more fixed thresholds of a reference diverter arm.

20. The non-transitory computer readable medium of claim 18, wherein the position sensor data are provided by at least one accelerometer affixed to the diverter arm.
